(19) United States
(12) Patent Application Publication
(10) Pub. No.: US 2014/0096791 A1
(43) Pub. Date: Apr. 10, 2014

(54) Ice Prevention System and Method for Power Lines

(71) Applicants: Matthew Braden Luther, Zachary, LA (US); Andrew Robert Varrenti, Sugarland, TX (US); Allen Taflove, Skokie, IL (US)

(72) Inventors: Matthew Braden Luther, Zachary, LA (US); Andrew Robert Varrenti, Sugarland, TX (US); Allen Taflove, Skokie, IL (US)

(21) Appl. No.: 13/649,085

(22) Filed: Oct. 10, 2012

(51) Int. Cl. B08B 17/02

(52) U.S. Cl. CPC B08B 17/02
USPC 134/1

(57) ABSTRACT

A method for preventing the build-up of ice on overhead power lines using induced vibrations and hydrophobic chemical treatment. In one embodiment, audio frequency transducers are used to send low frequency vibrations down a transmission line, while a hydrophobic coating is applied before inclement weather. These vibrations add just enough energy to prevent ice nucleation, and create constructive interference patterns to assist in shaking off water before it freezes.

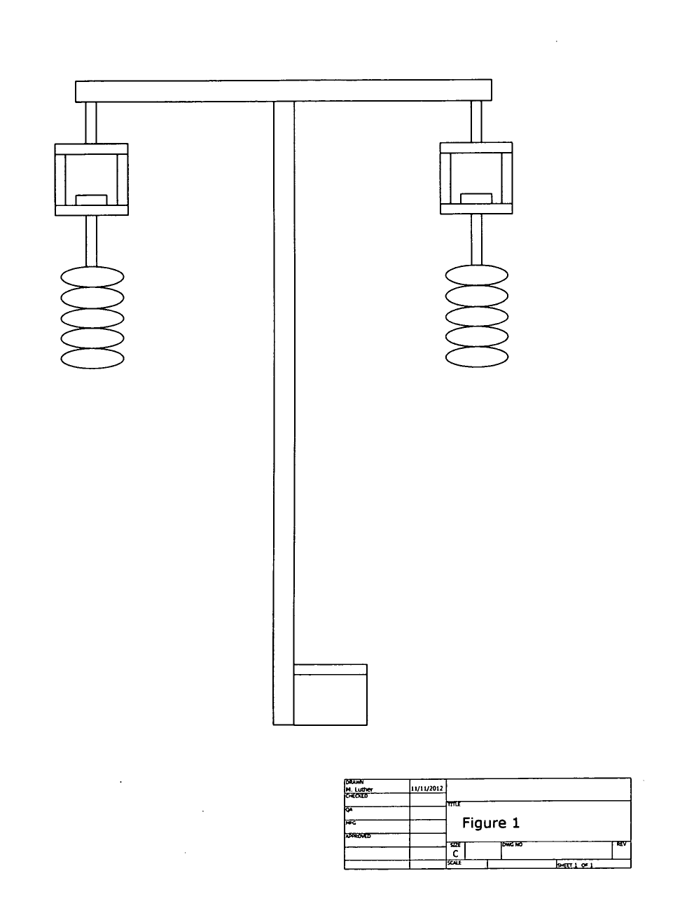

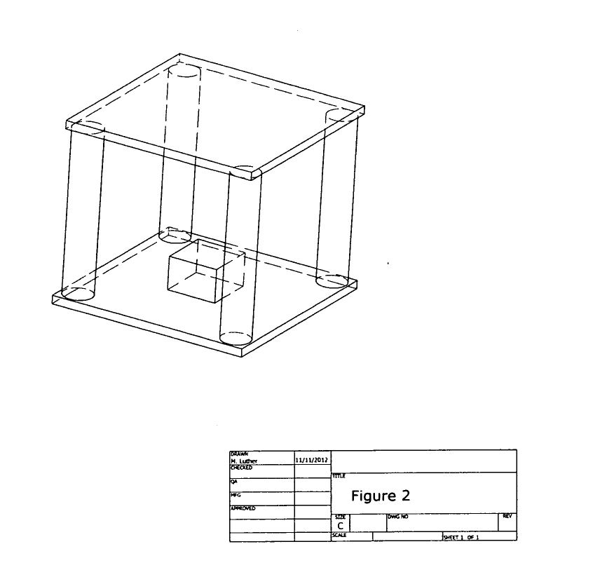

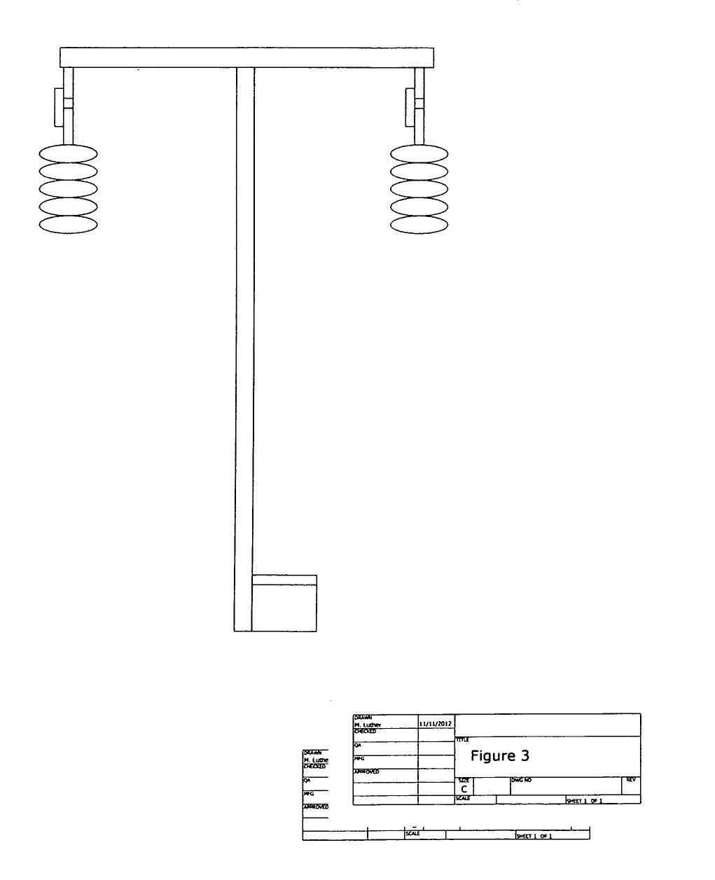

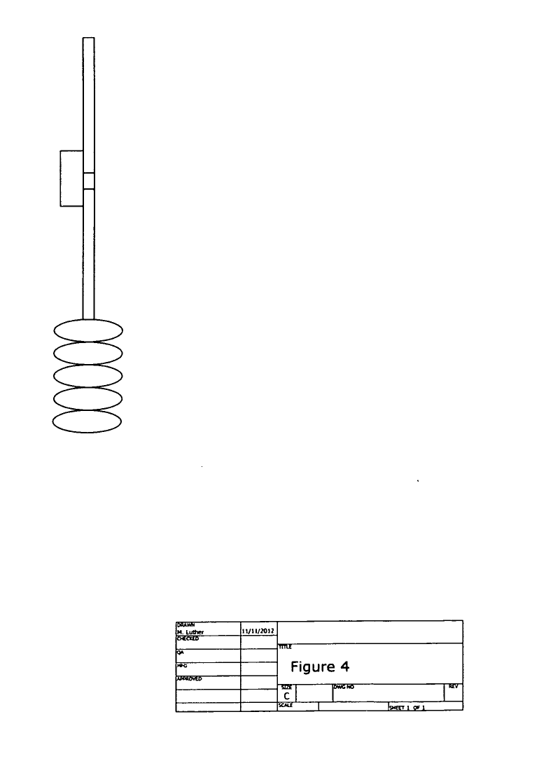

### CROSS REFERENCE TO RELATED APPLICATIONS

Provisional Patent 61/627,384 filing date Oct. 11, 2011, inventors Matthew Luther, Andrew Varrenti, and Allen Taflove.

### SEQUENCE LISTING OR PROGRAM

Not Applicable

### FEDERALLY SPONSORED RESEARCH

Not Applicable

### FIELD OF THE INVENTION

This invention applies to over head power lines, specifically ice prevention on overhead power lines.

### DESCRIPTION

### Background

### Problem

Every year winter brings freezing temperatures, powerful storms, and ice. This season causes significant damage to the electric grid in northern areas, many times reaching into the billions of dollars. This is not to mention the cost to people living in affected areas. As soon as one layer of ice builds up on a power line in an affected area, it becomes are foregone conclusion that ice will accumulate with devastating results. In extremely bad conditions, namely freezing rain, whole corridors of the grid can be crushed under the weight of accumulated ice. The damage usually takes weeks to repair.

### SUMMARY OF THE INVENTION

By bombarding the lines with vibrations, two important objectives are accomplished, each of which is assisted by the hydrophobic coating. First, nucleation of the water to form ice is prevented by adding just enough energy to the water molecules to keep them from crossing the phase boundary. Preventing a state change is much more efficient than reversing a state change. Second, the vibrations help prevent water from building up and sitting on the line. The chemical reinforces both stages of the vibrations. First, the chemical causes water to bead-up, which increases the energy cost of freezing that water. The chemical assists the second goal of the vibrations in two ways. The hydrophobic coating makes the water easier to shake off before it freezes, and when it does freeze, it reduces the strength of the adhesion to the line, making it easier to slough the ice off.

### Prior Art

State-of-the-art power line de-icing (1998)—Presents information pertaining to different de-icing techniques that have been developed or were in development at the time, and discloses force vibration methods under the category of mechanical techniques.

U.S. Pat. No. 6,660,934 B1—“Power line ice shedder” uses a motor to move a weight attached to the cable which translates vibrations to the cable

Publication No. US 2004/0065458 A1—“Means and method for removing extraneous matter like ice/snow from an overhead line” uses a controllable electromechanical vibrator

Publication No. US 2010/0031972—“Ultrasonic vibration system and method for removing/avoiding unwanted build-up on structures” uses an ultrasonic actuator along a specialized wave guide.

U.S. Pat. No. 7,310,948 B2—“De-icer for suspended overhead lines” uses a lateral vibration (shake) to prevent ice from accumulating and/or remove ice deposits that have formed by applying a perpendicular force to a power line to displace it laterally and then suddenly releases it.

### BRIEF DESCRIPTION OF THE DRAWINGS

Drawing 1. Box Mount on Line—Depicts how a transducer would be attached to a line with a frame.

Drawing 2. Box Mount Apparatus—Depicts an example “box” frame a transducer can be mounted on.

Drawing 3. Line Mount on Line—Depicts where a transducer would be attached to a line without a frame.

Drawing 4. Line Mount—Depicts how a transducer would be attached to a line without a frame.

### DETAILED DESCRIPTION OF THE INVENTION

The embodiments described herein are exemplary and are not intended to limit the scope of the invention, which is defined in the claims below.

The term “de-icing” is used in a general sense in this specification. It refers to systems and methods for removing ice and snow. It also refers to preventing the formation of ice and snow altogether, as well as preventing significant deposits of ice and snow. It also refers to melting of snow and ice. Throughout this specification, reference is often made to “ice”. The term “ice” refers generally to all forms of frozen water, including snow.

Surprisingly, low frequency vibrations—in particular, below 1 kHz—induced in power lines are much more effective at preventing and removing ice build-up than higher frequencies. Not only does it remove and prevent ice build-up better, it is less energy intensive. In particular, those frequencies below 1 kHz work the best. Higher frequency vibrations require much more energy to generate, making it harder to power them. In addition, the higher frequency vibrations attenuate much quicker than lower frequency vibrations. This surprising effectiveness of the low frequency vibrations paired with a powerful hydrophobic chemical allows power lines to remain ice free.

A common embodiment of this design will have a structure inserted between the top of a stack of insulators and the support pole. This structure can be an open-sided box design, with a solid top and bottom. The transducer will be attached to the center of the bottom plate. This saves unnecessary material weight from the sides. Many variations on this frame can be created: full sides, two triangles, cylindrical, etc. From the transducer, large gauge wires will be run down the pole to the ground, where the control box will be located. Inside the control box will be a power source, and signal generator. The box will be insulated and weatherized. This keeps as much weight off the pole structure as possible. The hydrophobic coating will be applied to the line differently depending on the type used, but will always be applied before weather.

1. A method for preventing ice build-up on power lines, comprising of:
A. applying hydrophobic chemicals to said line, and
B. inducing low frequency vibrations onto said line, wherein
i. said low frequency vibrations are below one kilohertz, whereby energy is more efficiently transmitted along the length of said line.

2. A method for removing ice build-up on power lines, comprising of:
A. applying hydrophobic chemicals to said line, and
B. inducing low frequency vibrations onto said line, wherein
i. said low frequency vibrations are below one kilohertz, whereby energy is more efficiently transmitted along the length of said line.
